(19) United States
(12) Patent Application Publication
(10) Pub. No.: US 2008/0120571 A1
(43) Pub. Date: May 22, 2008

(54) METHOD FOR DISPLAYING ICONS OF DIGITAL ITEMS

(75) Inventors: Chien-Chuan Chang, Taipei City (TW); Ming-Huang Lin, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ULEAD SYSTEMS, INC., Taipei (TW)

(21) Appl. No.: 11/616,895

(22) Filed: Dec. 28, 2006

(30) Foreign Application Priority Data
Nov. 22, 2006 (TW) 95143157

(51) Int. Cl. G06F 3/048

(52) U.S. Cl. 715/810

(57) ABSTRACT

A method for displaying icons of digital items is provided. In the present invention, a stacking manner is used for displaying all icons of the digital items in a visible region of a window. As a result, no matter how many digital items stored in the corresponding window, a user can traverse all the digital items without dragging a scrollbar, and thus the convenience of traversing digital items can be improved. Furthermore, the present invention provides the ability for user to customize a layout of the window by adjusting the overlapping degree and stacking manner of the icons, thereby making the way of displaying the icons of the digital items more flexible.

### CROSS-REFERENCE TO RELATED APPLICATION

This application claims the priority benefit of Taiwan application serial no. 95143157, filed Nov. 22, 2006. All disclosure of the Taiwan application is incorporated herein by reference.

### BACKGROUND OF THE INVENTION

1. Field of the Invention

The present invention relates to a method for displaying icons of digital items, and more particularly to a method for displaying all icons of the digital items in a window.

2. Description of Related Art

With the progress of science and technology, and the trend of the gradually increasing prevalence of computers, using computers has become an indispensable part of modern peoples' daily life, and the user has gradually got used to using the computer as a tool for storing data files. Generally, the files are stored in the computer in the form of thumbnails, tiles, icons, list, or details, for the user to traverse. Especially for the picture or multimedia audio-visual files, the thumbnail traversing function helps the user to quickly know the original content of the files through viewing the thumbnails, thereby easily recognizing the demanded file from a plurality of data files.

As shown in FIG. 1, the window 110 has been opened to the maximum visible region state, and in the window 110, the file thumbnails are displayed in a form similar to an array, and in each horizontal row of the window 110, the number of thumbnails that can be displayed is fixed. Taking FIG. 1 as an example, in the window 110, only 4 file thumbnails can be displayed in each horizontal row, that is to say, 12 complete file thumbnails (indicated by the oblique-line rectangles in FIG. 1) can be displayed in the visible region of the window 110. When the number of file thumbnails has exceeded the maximum number that can be displayed in the visible region of the window, that is, there are still file thumbnails, such as a file thumbnail 130, a file thumbnail 140, a file thumbnail 150 and a file thumbnail 160, that cannot be displayed completely, and some file thumbnails even cannot appear in the visible region of the window 110, the user must drag the scrollbar 120 beside the window up and down, so as to traverse these files.

If there are not so many files for being traversed in the window, this process may only cause a certain inconvenience for the user. However, if there is a great deal of files in the window, the user must frequently drag the scrollbar up and down in order to traverse all the files. In this way, no matter the user wants to select the desired file and open it or to select several files for performing other operations, he/she cannot view the displaying manner of all the file thumbnails at one time, which causes a large trouble for the user.

### SUMMARY OF THE INVENTION

Accordingly, the present invention is directed to providing a method for displaying icons of digital items, which is capable of displaying all the icons of the digital items in a visible region of a window, thereby being convenient for a user to traverse all the icons of the digital items.

As embodied and broadly described herein, the present invention provides a method for displaying icons of digital items, which comprises providing a plurality of icons, for representing a plurality of digital items; and stacking the icons, such that the icons are all displayed in a visible region of a window.

In the method for displaying the icons of the digital items according to a preferred embodiment of the present invention, the method of stacking the icons comprises adjusting an overlapping degree for the icons arranged in a horizontal direction according to a horizontal adjustment parameter.

In the method for displaying the icons of the digital items according to a preferred embodiment of the present invention, it further comprises determining a number of displayed icons in each horizontal row in the visible region according to the horizontal adjustment parameter, and stacking the icons in each horizontal row within the visible region according to the number of displayed icons.

In the method for displaying the icons of the digital items according to a preferred embodiment of the present invention, it further comprises providing an input interface, and adjusting a value of the horizontal adjustment parameter according to an input value of the input interface.

In the method for displaying the icons of the digital items according to a preferred embodiment of the present invention, the input interface comprises one of a draggable slider, a drag-board panel, a wheel control, a spin button, a textbox, or a combobox.

In the method for displaying the icons of the digital items according to a preferred embodiment of the present invention, the method of stacking the icons comprises adjusting an overlapping degree for the icons arranged in a vertical direction according to a vertical adjustment parameter.

In the method for displaying the icons of the digital items according to a preferred embodiment of the present invention, it further comprises determining a number of displayed icons in each vertical column within the visible region according to the vertical adjustment parameter, and stacking the icons in each vertical column within the visible region according to the number of displayed icons.

In the method for displaying the icons of the digital items according to a preferred embodiment of the present invention, it further comprises providing an input interface, and adjusting a value of the vertical adjustment parameter according to an input value of the input interface.

In the method for displaying the icons of the digital items according to a preferred embodiment of the present invention, the input interface comprises one of a draggable slider, a drag-board panel, a wheel control, a spin button, a textbox, or a combobox.

In the method for displaying the icons of the digital items according to a preferred embodiment of the present invention, the method of stacking the icons comprises determining the stacking manner of the icons according to an overlapping rule.

In the method for displaying the icons of the digital items according to a preferred embodiment of the present invention, the overlapping rule comprises stacking next icon at the lower right, lower left, upper right or upper left of the previous icon.

In the method for displaying the icons of the digital items according to a preferred embodiment of the present invention, the method of stacking the icons comprises stacking the icons into a plurality of sub-stacks according to a depth adjustment parameter, wherein the number of the icons in each sub-stack is less than a value of the depth adjustment parameter.

In the method for displaying the icons of the digital items according to a preferred embodiment of the present invention, it further comprises providing an input interface, and adjusting the value of the depth adjustment parameter according to an input value of the input interface.

In the method for displaying the icons of the digital items according to a preferred embodiment of the present invention, wherein the input interface comprises one of a draggable slider, a drag-board panel, a wheel control, a spin button, a textbox, or a combobox.

In the method for displaying the icons of the digital items according to a preferred embodiment of the present invention, it further comprises changing the shape of the icons.

In the method for displaying the icons of the digital items according to a preferred embodiment of the present invention, it further comprises rotating the icons.

In the present invention, the icons of the digital items are displayed in the visible region of the window by stacking, and thus the user can traverse all the icons of the digital items in the visible region of the window, without dragging a scrollbar, thereby enhancing the convenience of traversing the digital items. Furthermore, in the present invention, the user can adjust the stacking manner, and thereby making the displaying method more flexible.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the rules of the invention.

FIG. 1 is a schematic view of displaying files by way of traversing the thumbnail according to the conventional art.

FIG. 2 is a flow chart of a method for displaying icons of the digital items according to a preferred embodiment of the present invention.

FIG. 3 is a schematic view of icons of the digital items.

FIG. 4 is a schematic view of icons of the digital items.

FIG. 5 is a schematic view of icons of the digital items.

FIG. 6 is a schematic view of icons of the digital items.

FIG. 7 is a schematic view of a window of a folder.

FIG. 8 is a schematic view of a window of a folder.

FIG. 9 is a schematic view of a window of a folder.

FIG. 10 is a schematic view of a window of a folder.

FIG. 11 is a schematic view of a draggable slider.

FIG. 12 is a schematic view of a drag-board panel.

FIG. 13 is a schematic view of a wheel control.

FIG. 14 is a schematic view of a spin button.

FIG. 15 is a schematic view of a textbox.

FIG. 16 is a schematic view of a combobox.

FIG. 17 is a schematic view of a window of a folder.

FIG. 18 is a schematic view of a window of a folder.

FIG. 19 is a schematic view of a window of a folder.

FIG. 20 is a schematic view of a window of a folder.

FIG. 21 is a schematic view of a window of a folder.

FIG. 22 is a schematic view of a stacking manner of icons.

FIG. 23 is a schematic view of a stacking manner of icons.

FIG. 24 is a schematic view of a stacking manner of icons.

FIG. 25 is a schematic view of a stacking manner of icons.

FIG. 26 is a schematic view of a window of a folder.

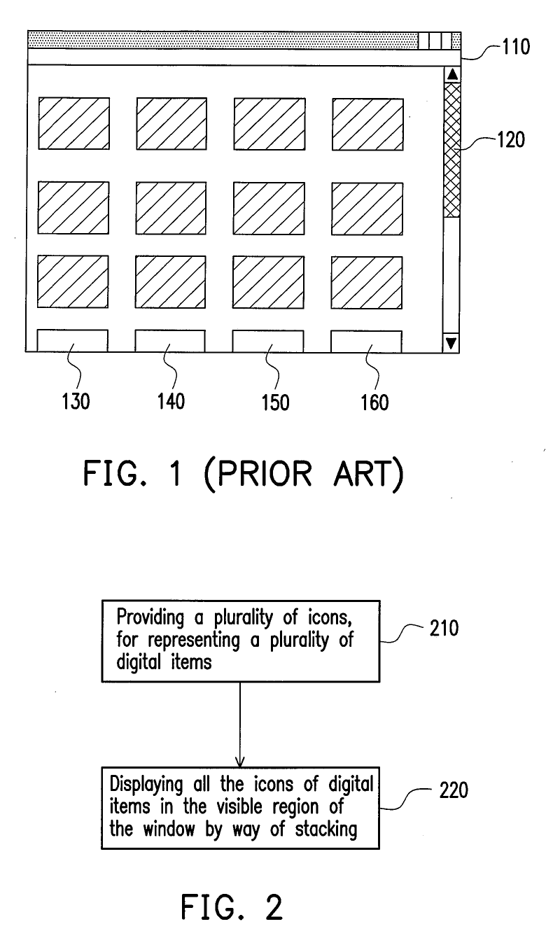

### DESCRIPTION OF EMBODIMENTS

To make the content of the present invention more comprehensible, the following embodiments are taken as examples for implementing the present invention accordingly.

Generally, the number of digital items that can be displayed in a visible region in a window of a folder or in a window of an application of an electronic device is fixed. Therefore, when the number of digital items in the window exceeds a certain level, and the digital items cannot be completely displayed in the visible region of the window, conventionally, a scrollbar is produced within the window, and thus a user must traverse all the digital items by scrolling up or down the scrollbar. However, if the digital items are arranged by way of stacking, the space required is apparently saved, and the number of digital items displayed within the visible region of the window is increased, thereby being convenient for the user to traverse. The present invention is directed to a method for displaying icons of digital items that is developed based upon this rule.

FIG. 2 is a flow chart of a method for displaying icons of the digital items according to a preferred embodiment of the present invention. Referring to FIG. 2, in this embodiment, first, a plurality of icons is provided, for representing a plurality of digital items (Step 210). The digital item includes, but not limited to, for example, text files, music files, picture files, or audio-video files. The icons for representing the digital items are, for example, icons corresponding to the type of files of the digital item, or thumbnails for previewing the digital items. Then, in Step 220, the icons of digital items are all displayed in the visible region of the window by way of stacking. It should be noted that, under the circumstance of not changing the size of the window itself, the visible region of the window is fixed.

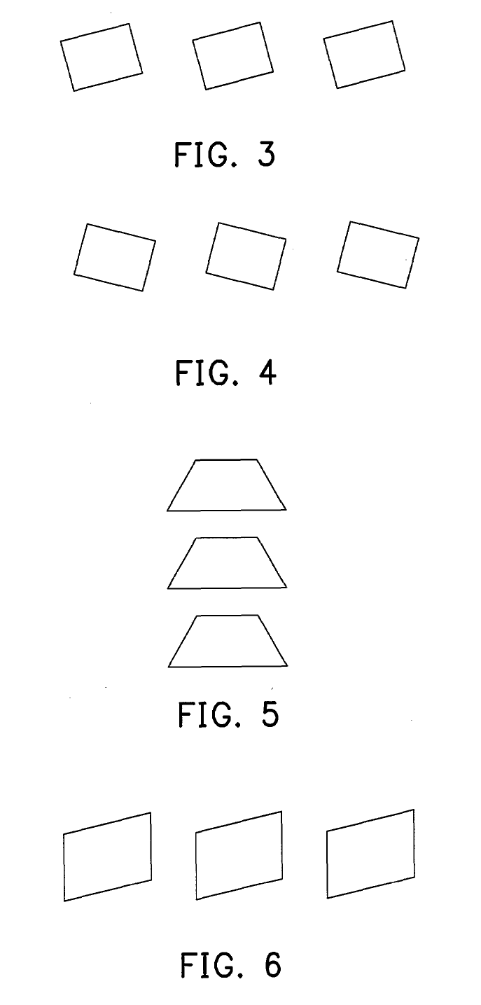

In another embodiment, a step of changing the appearance of the icons is further included before or after Step 220. For example, each icon is generally displayed in the window in the form of being upright and foursquare. However, the display effects can be changed by rotating the icons (as shown in FIG. 3 or FIG. 4). Besides, the shape of the icons can be changed, for example, from the original rectangle into various different geometric shapes such as trapezium (as shown in FIG. 5) or parallelogram (as shown in FIG. 6), such that the icons are more stereoscopic or perspective when being displayed, but it is not limited in the present invention.

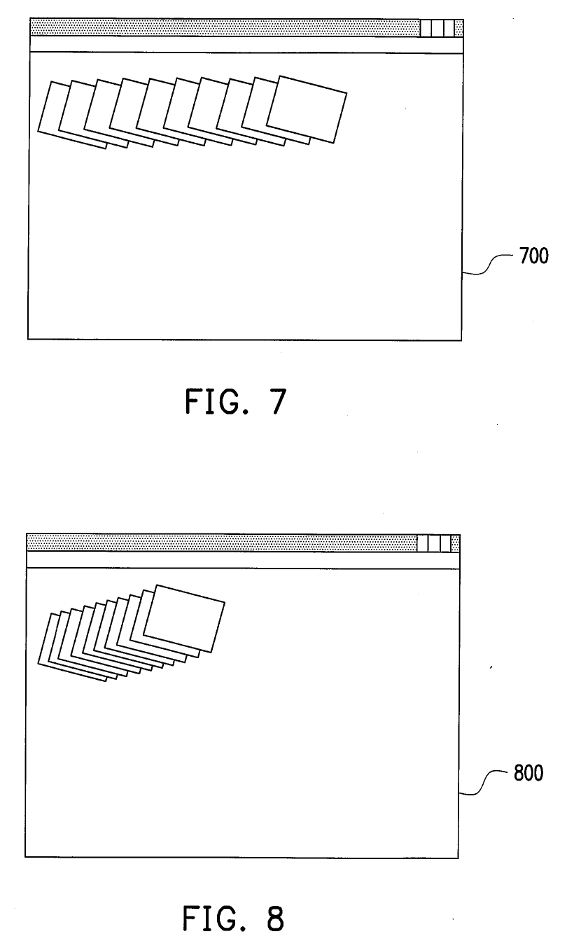

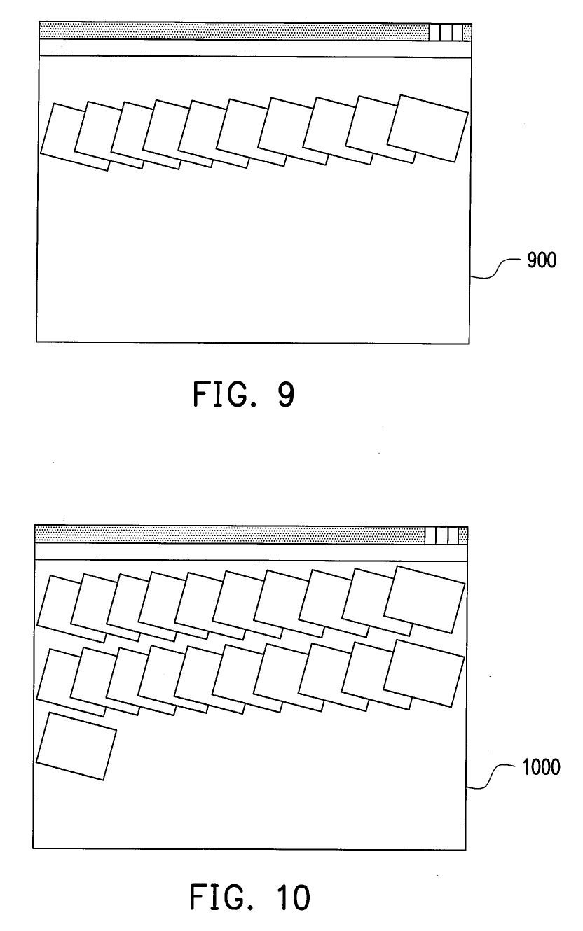

In order to facilitate the illustration, thumbnails of picture files displayed in a folder window of a personal computer are taken as an example in the following embodiments. In an embodiment of the present invention, it is presumed 10 picture files are stored in a folder, and the traversing function of the folder has been pre-set as a thumbnail traversing mode, that is to say, the 10 picture files are displayed in the folder window as thumbnails. Therefore, as shown in FIG. 7, the method of stacking the thumbnails of the picture files in a folder window 700 includes, for example, adjusting an overlapping degree for the thumbnails of the 10 picture files arranged in the horizontal direction according to a horizontal adjustment parameter, thereby displaying all the thumbnails in the folder window 700 at one time. Referring to both FIG. 8 and FIG. 9, in this embodiment, if the value of the horizontal adjustment parameter is relatively large, it indicates that all the thumbnails in a folder window 800 are arranged in the horizontal direction with a higher density in terms of the overlapping degree; on the contrary, if the value of the horizontal adjustment parameter is relatively low, it indicates that all the thumbnails in a folder window 900 are arranged in the horizontal direction with a lower density in terms of the overlapping degree.

In another embodiment, the method of stacking all the thumbnails in the folder window further includes, for example, determining a number of displayed icons according to the horizontal adjustment parameter, wherein the number of displayed icons is used for indicating the maximum number of icons that can be displayed in each horizontal row within the visible region of the folder window. For example, as shown in FIG. 10, when the number of thumbnails of the picture files in a folder window 1000 (for example, 21) is larger than the number of displayed icons (for example, 10), after the 10 thumbnails have already been stacked and displayed in the first horizontal row of the folder window 1000, the thumbnails are stacked continuously in the next horizontal row of the folder window 1000 by adjusting the overlapping degree among the thumbnails according to the horizontal adjustment parameter, until all the thumbnails are displayed in the visible region of the folder window 1000.

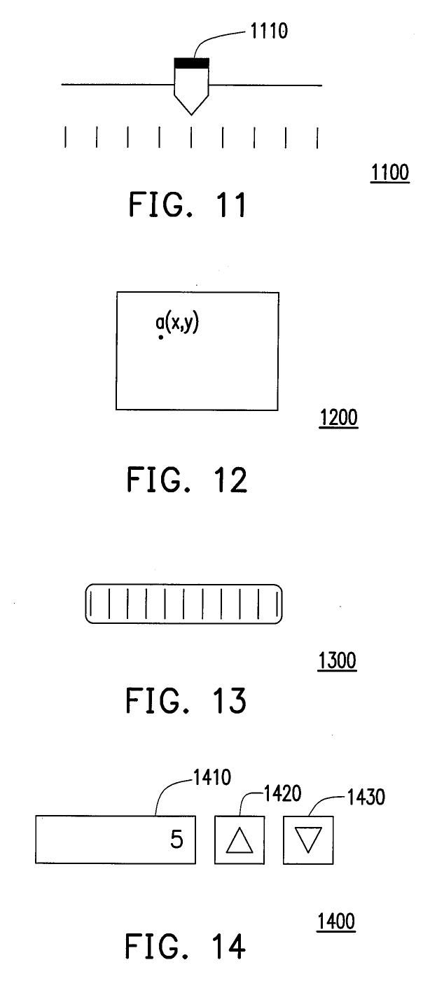

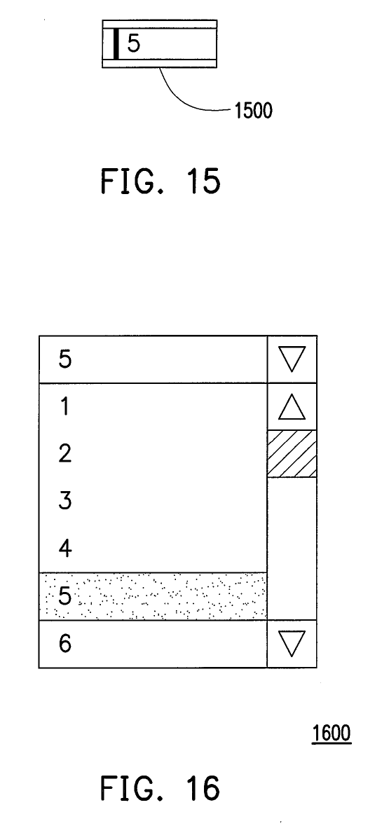

It should be noted that, the user can customize the value of the horizontal adjustment parameter through an input interface according to own demands or habits, so as to adjust the overlapping degree for the thumbnails in the horizontal direction, and thereby changing the displaying state of the folder window. For example, referring to FIG. 11, the user may use a draggable slider 1100, and set the value of the horizontal adjustment parameter by dragging the draggable slider 1100 and based upon a moving position of a slider 1110 of the draggable slider 1100. In another embodiment, referring to FIG. 12, the user may use a drag-board panel 1200, and adjust the value of the horizontal adjustment parameter by adjusting coordinates (x, y) of a reference point a in the drag-board panel 1200 and based upon the horizontal coordinate x of the reference point a. Referring to FIG. 13, the user may use a wheel control 1300, and adjust the value of the horizontal adjustment parameter by rolling the wheel control 1300 and based upon a scale value of the wheel control 1300. As shown in FIG. 14, the user can increase the number displayed in a text block 1410 by clicking a spin button 1420, or decrease the number in the text block 1410 by clicking a spin button 1430, and the user can adjust the value of the horizontal adjustment parameter based upon the number in the text block 1410. In addition, the user can adjust the value of the horizontal adjustment parameter by directly inputting a data input value into a textbox 1500 of FIG. 15. Alternatively, the value of the horizontal adjustment parameter can be adjusted by utilizing a combobox 1600 shown in FIG. 16, and through selecting a menu option in the combobox 1600. However, besides the several implementing examples listed above, any input device that enables the user to perform the input operation can be used as an input interface for the present invention, which is not limited in the present invention. Besides, the user can set the horizontal adjustment parameter by inputting values through a keyboard, mouse, digital pen, joystick, touch-screen, or through speech, but the present invention is not limited to that.

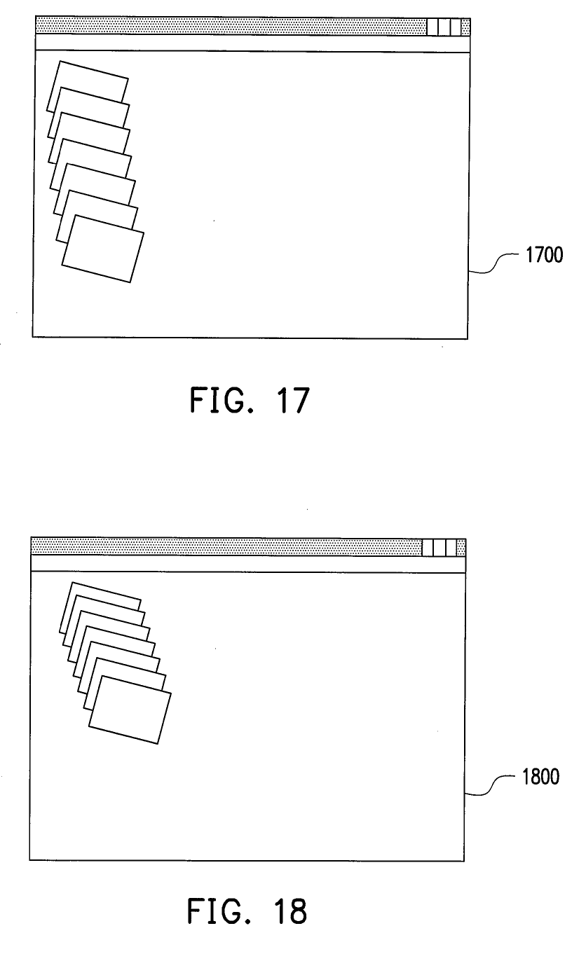

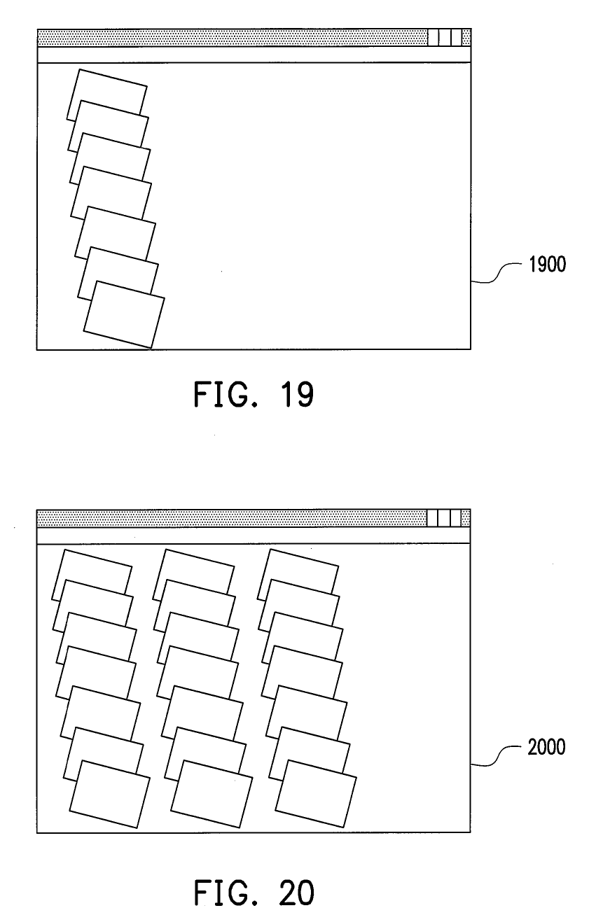

Besides changing the overlapping degree for the thumbnails of the picture files according to the horizontal adjustment parameter, in another embodiment, for example, the overlapping degree for all the thumbnails in the vertical direction also can be adjusted according to a vertical adjustment parameter, so as to display all the thumbnails in the visible region of the folder window at one time. As shown in FIG. 17, it is presumed 7 picture files are stored in a folder window 1700, the overlapping degree between two thumbnails in the thumbnails of the picture files is adjusted according to the value of the vertical adjustment parameter, and then the thumbnails are stacked and displayed in the folder window 1700. Referring to both FIG. 18 and FIG. 19, in this embodiment, if the value of vertical adjustment parameter is relatively large, it indicates that, for example, the thumbnails are arranged in a folder window 1800 in the vertical direction with a higher density in terms of the overlapping degree; whereas if the value of the vertical adjustment parameter is relatively low, it indicates that, for example, the thumbnails are arranged in a folder window 1900 in the vertical direction with a lower density in terms of the overlapping degree.

Referring to FIG. 20, in this embodiment, the method of stacking the thumbnails of the picture files further includes determining a number of displayed icons according to the vertical adjustment parameter, wherein the number of displayed icons is used for indicating the maximum number of thumbnails of the picture files that can be displayed in each vertical column within the visible region of a folder window 2000. Particularly, it is presumed 21 picture files are stored in the folder window 2000, it is determined according to the vertical adjustment parameter that the number of displayed icons is 7, and thus after the thumbnails of the 7 picture files have been displayed in the first vertical column of the folder window 2000, the overlapping degree between thumbnails in the next vertical column is also adjusted according to the vertical adjustment parameter, and the thumbnails are continuously displayed in the next vertical column until all the thumbnails are displayed in the visible region of the folder window 2000.

In this embodiment, the user still can change the displaying state of the folder window through an input interface by way of customizing the value of the vertical adjustment parameter. The process of setting the vertical adjustment parameter includes, for example, setting the value of the vertical adjustment parameter through the draggable slider 1100 shown in FIG. 11 by dragging the slider 1110 of the draggable slider and based upon a moving position of the slider 1110. Furthermore, referring to FIG. 12, the user can adjust the value of the vertical adjustment parameter by adjusting the coordinates (x, y) of the reference point a in the drag-board panel 1200 and based upon the vertical coordinate y of the reference point a. Referring to FIG. 13, the user can adjust the value of the vertical adjustment parameter by rolling the wheel control 1300 and based upon the scale value of the wheel control 1300. As shown in FIG. 14, the user can adjust the value of the vertical adjustment parameter by clicking the spin button 1420 in order to increase the number displayed in the text block 1410, or clicking the spin button 1430 in order to decrease the number displayed in the text block 1410, and based upon the number in the text block 1410. In addition, the user can adjust the value of the vertical adjustment parameter by directly inputting a data input value in the textbox 1500 in FIG. 15. Alternatively, the value of the vertical adjustment parameter can be adjusted by utilizing the combobox 1600 shown in FIG. 16, and through selecting the menu option in the combobox 1600. However, besides the several implementing examples listed above, any other input device that enables the user to perform the input operation can be used as an input interface for the present invention, but the present invention is not limited to this. Besides, the user can set the vertical adjustment parameter by inputting values through, for example, a keyboard, mouse, digital pen, joystick, touch-screen, or through speech, but the present invention is not limited to that.

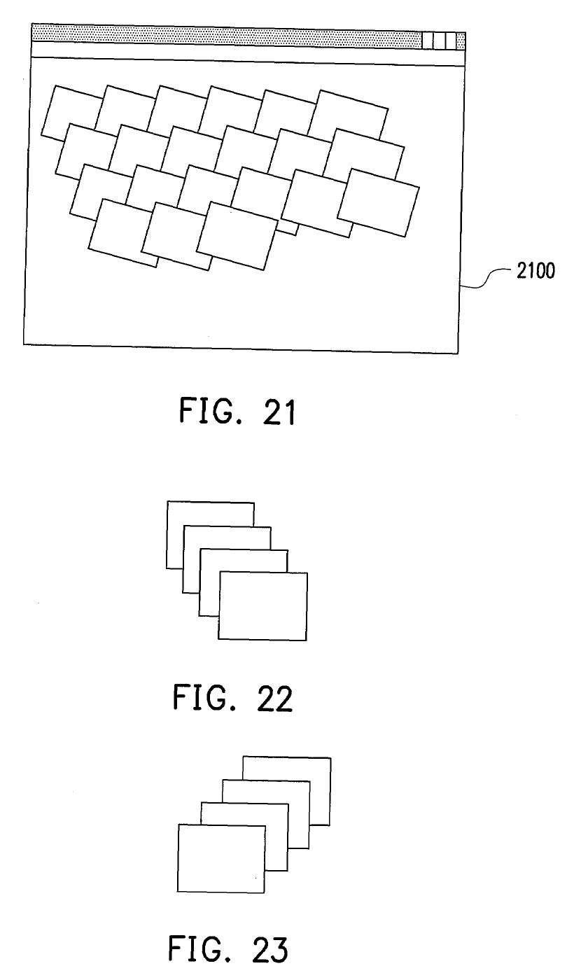

In another embodiment, besides adjusting the overlapping degree for the thumbnails in the horizontal direction according to the horizontal adjustment parameter, or adjusting the overlapping degree for the thumbnails in the vertical direction according to the vertical adjustment parameter, the method of stacking the thumbnails of the picture files in the folder window further includes adjusting the overlapping degree and stacking manner of the thumbnails according to both the horizontal adjustment parameter and the vertical adjustment parameter, and thereby displaying all the thumbnails in the visible region of the folder window. As shown in FIG. 21, the thumbnails of 21 picture files are stacked in a folder window 2100 according to both the horizontal adjustment parameter and the vertical adjustment parameter. It is easy to find that, compared with the two displaying states that the thumbnails are only overlapped with each other in the horizontal direction (shown by the folder window 1000 in FIG. 10), and that the thumbnails are overlapped with each other in the vertical direction (shown by the folder window 2000 in FIG. 20), in the folder window 2100, the thumbnails are overlapped with each other both on the vertical and horizontal directions.

In this embodiment, the user can set the values of both the horizontal adjustment parameter and the vertical adjustment parameter. The method of adjusting the values of the horizontal adjustment parameter and the vertical adjustment parameter respectively includes, for example, changing coordinates (x, y) of the reference point a of a drag-board panel on the user interface and based upon the horizontal coordinate x and the vertical coordinate y of the reference point a. For example, when the user reduces the horizontal coordinate of the reference point a in the drag-board panel to be half (e.g., 5) of the original value (e.g., 10), the value of the horizontal adjustment parameter is reduced to be half (e.g., 4) of the original value (e.g., 8). When the user enlarges the vertical coordinate of the reference point a in the drag-board panel to be twice (e.g., 40) of the original value (e.g., 20), the value of the vertical adjustment parameter also becomes twice (e.g., 18) of the original value (e.g., 9).

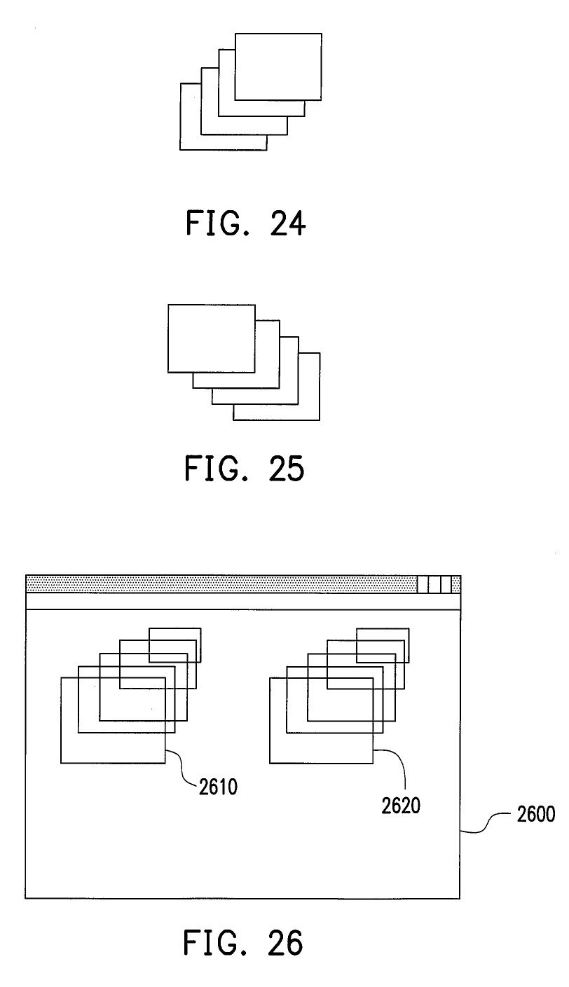

In another embodiment of the present invention, the method for stacking the thumbnails of the picture files further includes, for example, determining the stacking manner of the thumbnails according to an overlapping rule, wherein the stacking manner refers to the relative position between two thumbnails. The overlapping rule includes, for example, stacking the next thumbnail at the lower right of the previous thumbnail (shown in FIG. 22) each time when stacking the thumbnails, or stacking the next thumbnail at the lower left of the previous thumbnail (shown in FIG. 23) each time when stacking the thumbnails. Besides, the overlapping rule also includes, but not limited to, stacking the next thumbnail at the upper right of the previous thumbnail (shown in FIG. 24), or stacking the next thumbnail at the upper left of the previous thumbnail (shown in FIG. 25). The user can change the stacking manner of the thumbnails in the folder window through selecting different overlapping rules.

In still another embodiment of the present invention, the method of stacking the thumbnails in the visible region of the folder window further includes, for example, stacking all the thumbnails into several sub-stacks according to a depth adjustment parameter, wherein in each sub-stack, the number of the thumbnails is no larger than the value of the depth adjustment parameter. Referring to FIG. 26, in this embodiment, it is presumed the value of the depth adjustment parameter is 5, in a folder window 2600, at most the thumbnails of 5 picture files can be stacked in a sub-stack 2610 and a sub-stack 2620 respectively.

In this embodiment, the user still can adjust the value of the depth adjustment parameter by inputting a value through an input interface. For example, referring to FIG. 11, the user can adjust the value of the depth adjustment parameter by operating the draggable slider 1100, and based upon the moving position of the slider 1110 of the draggable slider 1100. For example, moving the slider 1110 towards right indicates, for example, increasing the value of the depth adjustment parameter, thereby increasing the number of the thumbnails in each sub-stack; and moving the slider 1110 towards left indicates, for example, reducing the value of the depth adjustment parameter, thereby reducing the number of the thumbnails in each sub-stack. Besides, referring to FIG. 12, the user can adjust the value of the depth adjustment parameter through adjusting the coordinates (x, y) of the reference point a in a drag-board panel 1200 and based upon the coordinates (x, y) of the reference point a. Then, referring to FIG. 13, the user also can adjust the value of the depth adjustment parameter through rolling the wheel control 1300 and based upon the scale value of the wheel control 1300. In addition, as shown in FIG. 14, the user can adjust the value of the depth adjustment parameter by clicking the spin button 1420 to increase the number displayed in the text block 1410, or clicking the spin button 1430 to reduce the number displayed in the text block 1410, and based upon the number displayed in the text block 1410. In addition, the user also can adjust the value of the depth adjustment parameter by directly inputting a data input value into the textbox 1500 of FIG. 15. Alternatively, the value of the depth adjustment parameter can be adjusted by utilizing the combobox 1600 as shown in FIG. 16 and through selecting the menu option in the combobox 1600. However, besides the several implementing example listed above, any input device that enables the user to perform the input operation can be used as an input interface for the present invention, which is not limited in the present invention. Besides, the user can set the depth adjustment parameter by inputting values through a keyboard, mouse, digital pen, joystick, touch-screen, or through speech, but the present invention is not limited to that.

Although the thumbnails of the picture files displayed by stacking are taken as an example in the above embodiments, icons or thumbnails of other types of digital items such as text files, music files, or audio-visual files also can be displayed through the method for displaying the icons of the digital items of the present invention, which all can be displayed in the visible region of the window, and thus will not be described herein any more. It should be noted that, in the method for displaying icons of the digital items of the present invention, while stacking and displaying the icons, the user can also perform operations such as opening, copying, moving, or deleting on the digital items corresponding to the icons or thumbnails, according to the user's own demanding.

In view of the above, the method for displaying icons of the digital items in present invention is used for displaying all the icons of the digital items in the visible region of the window at one time by way of stacking. Through adjusting the overlapping degree and stacking manner between the icons, all the icons can be displayed in the visible region of the window regardless of the number of the digital items. The method of the present invention is not only helpful for the user to select the desired files from a plurality of digital items to perform the opening or editing operations, but also allows the user to set the displaying state of the window, and thereby greatly enhancing the convenience for traversing the digital items.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying icons of digital items, comprising:
providing a plurality of icons, for representing a plurality of digital items; and
stacking the icons, such that the icons are all displayed in a visible region of a window.

2. The method for displaying icons of digital items as claimed in claim 1, wherein the method of stacking the icons comprises:
adjusting an overlapping degree for the icons arranged in a horizontal direction, according to a horizontal adjustment parameter.

3. The method for displaying icons of digital items as claimed in claim 2, further comprising:
determining a number of displayed icons in each horizontal row within the visible region according to the horizontal adjustment parameter; and
stacking the icons in each horizontal row within the visible region according to the number of displayed icons.

4. The method for displaying icons of digital items as claimed in claim 2, further comprising:
providing an input interface; and
adjusting a value of the horizontal adjustment parameter according to an input value of the input interface.

5. The method for displaying icons of digital items as claimed in claim 4, wherein the input interface comprises one of a draggable slider, a drag-board panel, a wheel control, a spin button, a textbox, or a combobox.

6. The method for displaying icons of digital items as claimed in claim 1, wherein the method of stacking the icons comprises:
adjusting an overlapping degree for the icons arranged in a vertical direction according to a vertical adjustment parameter.

7. The method for displaying icons of digital items as claimed in claim 6, further comprising:
determining a number of displayed icons in each vertical column within the visible region according to the vertical adjustment parameter; and
stacking the icons in each vertical column within the visible region according to the number of displayed icons.

8. The method for displaying icons of digital items as claimed in claim 6, further comprising:
providing an input interface; and
adjusting a value of the vertical adjustment parameter according to an input value of the input interface.

9. The method for displaying icons of digital items as claimed in claim 8, wherein the input interface comprises one of a draggable slider, a drag-board panel, a wheel control, a spin button, a textbox or a combobox.

10. The method for displaying icons of digital items as claimed in claim 1, wherein the method of stacking the icons comprises:
determining the stacking manner of the icons according to an overlapping rule.

11. The method for displaying icons of digital items as claimed in claim 10, wherein the overlapping rule comprises:
stacking next icon at the lower right, lower left, upper right, and upper left of the previous icon.

12. The method for displaying icons of digital items as claimed in claim 1, wherein the method of stacking the icons comprises:
stacking the icons into at least one sub-stack according to a depth adjustment parameter, wherein the number of the icons in each sub-stack is less than a value of the depth adjustment parameter.

13. The method for displaying icons of digital items as claimed in claim 12, further comprising:
providing an input interface; and
adjusting the value of the depth adjustment parameter according to an input value of the input interface.

14. The method for displaying icons of digital items as claimed in claim 13, wherein the input interface comprises one of a draggable slider, a drag-board panel, a wheel control, a spin button, a textbox or a combobox.

15. The method for displaying icons of digital items as claimed in claim 1, further comprising:
changing the shape of the icons.

16. The method for displaying icons of digital items as claimed in claim 1, further comprising:
rotating the icons.
